(19) United States
(12) Patent Application Publication
(10) Pub. No.: US 2012/0256978 A1
(43) Pub. Date: Oct. 11, 2012

(54) METHOD OF DRIVING PLASMA DISPLAY DEVICE, PLASMA DISPLAY DEVICE, AND PLASMA DISPLAY SYSTEM

(76) Inventors: Takahiko Origuchi, Osaka (JP); Yuya Shiozaki, Osaka (JP); Shigeo Kigo, Osaka (JP); Yutaka Yoshihama, Osaka (JP); Mitsuhiro Ishizuka, Osaka (JP)

(21) Appl. No.: 13/515,655

(22) PCT Filed: Dec. 13, 2010
(86) PCT No.: PCT/JP2010/007211

§ 371 Date: Jun. 13, 2012

(30) Foreign Application Priority Data
Dec. 14, 2009 (JP) 2009-282501

(51) Int. Cl. G09G 3/28; G09G 5/10

(52) U.S. Cl. 345/691; 345/690; 345/63

(57) ABSTRACT

An address period is shortened while degradation of image display quality of a plasma display apparatus is suppressed. For this purpose, in a driving method for a plasma display apparatus, the following operation is performed. A field for the right eye and a field for the left eye are alternately displayed on the plasma display panel. In each of the field for the right eye and the field for the left eye, a subfield having a smallest luminance weight occurs first, a subfield having a largest luminance weight occurs next, and the other subfields occur thereafter. In the subfield having the smallest luminance weight and the subfield having the largest luminance weight, one-line address operation for applying a scan pulse to each scan electrode is performed. In the other subfields, two-line simultaneous address operation for applying a scan pulse simultaneously to two adjacent scan electrodes is performed.

### TECHNICAL FIELD

The present invention relates to a plasma display apparatus driving method, a plasma display apparatus, and a plasma display system that enable the user to stereoscopically view a stereoscopic image that is made of an image for the right eye and an image for the left eye alternately displayed on a plasma display panel, using a pair of shutter glasses.

### BACKGROUND ART

An AC surface discharge panel, i.e. a typical plasma display panel (hereinafter, simply referred to as “panel”), has a front substrate and a rear substrate opposed to each other. A plurality of display electrode pairs, each including a scan electrode and a sustain electrode, is formed on the front substrate. A plurality of data electrodes is formed on the rear substrate. A large number of discharge cells are formed between the substrates. Ultraviolet rays are generated by gas discharge in the discharge cells. The ultraviolet rays excite phosphors in the red color, green color, and blue color such that light is emitted for the display of a color image.

A typically used driving method for the panel is a subfield method. In the subfield method, gradations are displayed by dividing one field period into a plurality of subfields and causing light emission or no light emission in each discharge cell in each subfield. Each of the subfields has an initializing period, an address period, and a sustain period.

In the initializing period, an initializing operation is performed so as to cause an initializing discharge in the discharge cells and to form wall charge necessary for the subsequent address operation. In the address period, an address operation is performed so as to cause an address discharge selectively in the discharge cells in response to an image to be displayed and to form wall charge in the discharge cells. In the sustain period, a sustain operation is performed so as to apply sustain pulses in number predetermined for each subfield alternately to the scan electrodes and the sustain electrodes and to generate sustain discharge in the discharge cells. The sustain operation causes the phosphor layers to emit light in the discharge cells having undergone the address discharge, and lights the discharge cells at luminances corresponding to the gradation values of image signals. Thus, an image is displayed in the image display area of the panel.

The above subfield method has the following problem. When increases in the size and definition of the panel increase the number of scan electrodes, the time taken in the address period increases and thus the time usable for the sustain operation decreases.

In order to address this problem, a driving method for performing a “simultaneous address operation” is proposed. The simultaneous address operation is a driving method for performing an address operation by applying a scan pulse to a plurality of scan electrodes simultaneously (see Patent Literature 1, for example). The simultaneous address operation can shorten the time taken for the address operation and thus the address period, and thereby increase the number of subfields and increase the time taken for the sustain operation, for example.

Application of a plasma display apparatus as a three-dimensional (hereinafter, “3D”) image display apparatus is considered.

In this plasma display apparatus, an image for the right eye and an image for the left eye that form an image for stereoscopic view (3D image) are alternately displayed on a panel. The user views the image using a pair of special glasses, called shutter glasses.

A pair of shutter glasses includes a shutter for the right eye and a shutter for the left eye. In the period during which an image for the right eye is displayed on the panel, the right eye shutter is opened (in a state of transmitting visible light) and the left eye shutter is closed (in a state of blocking the visible light). In the period during which an image for the left eye is displayed, the left eye shutter is opened and the right eye shutter is closed. With this operation, the user can view the image for the right eye only with the right eye, and the image for the left eye only with the left eye. Thus, the user can stereoscopically view the display image.

In this manner, in order to display one 3D image in a plasma display apparatus used as a 3D image display apparatus, it is necessary to display two images, i.e. one image for the right eye and one image for the left eye. Thus, the user who views a 3D image through a pair of shutter glasses perceives the number of images displayed on the panel per second as a half the number of fields per second.

For instance, suppose the field frequency (the number of fields occurring per second) of images displayed on the panel is 60 Hz. In this case, when the images are ordinary images (2D images) instead of 3D images, sixty 2D images are displayed per second. When the images are 3D images, thirty 3D images are displayed per second.

Therefore, in order to display sixty 3D images per second, it is necessary to set the field frequency to 120 Hz, which is twice as high as 60 Hz. In this case, the time usable to display one image for the right eye or one image for the left eye is limited to a half the time usable to display one 2D image.

In such a case, as a method for reducing the time taken to drive the panel, the above driving method using the simultaneous address operation is effective. However, in the driving method using the simultaneous address operation, the resolution (hereinafter, “vertical resolution”) in the direction orthogonal to the scan electrodes (hereinafter, “vertical direction”) tends to degrade. For instance, in the case where a scan pulse is simultaneously applied to two adjacent scan electrodes, an address operation is performed on the two scan electrodes simultaneously. Thus, in an image displayed on the panel, the respective discharge cells formed on the adjacent two scan electrodes emit light in the same pattern. For this reason, in the direction orthogonal to the scan electrodes (vertical direction), the resolution of the image decreases to the resolution caused by a half the number of scan electrodes.

The following impairment is confirmed in an image with a low vertical resolution. When an image including a pattern of oblique lines is displayed with a low vertical resolution, the smoothness of the oblique lines are more likely to be impaired than that in the image with a high vertical resolution. Especially in a moving image where oblique lines move at a specific speed, degradation of oblique lines is conspicuous. Further, when image processing, such as dither processing (a technique used to display a larger number of gradation values), is performed on an image signal with a low vertical resolution, the smoothness of the pattern is impaired in a region that displays specific gradations.

When a 3D image is displayed by driving a panel by a driving method using simultaneous address operation in a plasma display apparatus used as a 3D image display apparatus, in order to ensure the image display quality, it is important to suppress the degradation of the image display quality.

### CITATION LIST

### Patent Literature

PTL1
Japanese Patent Unexamined Publication No. 2008-116894

### SUMMARY OF THE INVENTION

In a plasma display apparatus driving method,
the plasma display apparatus including:
   a panel having a plurality of discharge cells arranged therein, each of the discharge cells having a scan electrode, a sustain electrode, and a data electrode; and
   a driver circuit for driving the panel,
the driving method includes:
   alternately displaying a field for a right eye and a field for a left eye on the panel, an image signal for the right eye being displayed in the field for the right eye, an image signal for the left eye being displayed in the field for the left eye, in each of the field for the right eye and the field for the left eye, a subfield having the smallest luminance weight occurring first, a subfield having the largest luminance weight occurring next, and the other subfields occurring thereafter,
   in the subfield having the smallest luminance weight and the subfield having the largest luminance weight, performing one-line address operation for applying a scan pulse to each scan electrode, and
   in the other subfields, performing two-line simultaneous address operation for applying a scan pulse simultaneously to two adjacent scan electrodes.

This method stably causes an address discharge while shortening the address period so as to enhance the image display quality when a 3D image is displayed in the plasma display apparatus usable as a 3D image display apparatus. Thus, a smooth moving 3D image can be displayed on the panel.

A plasma display apparatus includes the following elements:
a panel having a plurality of discharge cells arranged therein, each of the discharge cells having a scan electrode, a sustain electrode, and a data electrode; and
a driver circuit for driving the panel.
   The driver circuit alternately displays a field for a right eye and a field for a left eye on the panel. An image signal for the right eye is displayed in the field for the right eye, and an image signal for the left eye is displayed in the field for the left eye. In each of the field for the right eye and the field for the left eye, a subfield having the smallest luminance weight occurs first, a subfield having the largest luminance weight occurs next, and the other subfields occur thereafter. In the subfield having the smallest luminance weight and the subfield having the largest luminance weight, the driver circuit performs one-line address operation for applying a scan pulse to each scan electrode. In the other subfields, the driver circuit performs two-line simultaneous address operation for applying a scan pulse simultaneously to two adjacent scan electrodes.

This configuration stably causes an address discharge while shortening the address period so as to enhance the image display quality when a 3D image is displayed in the plasma display apparatus usable as a 3D image display apparatus. Thus, a smooth moving 3D image can be displayed on the panel.

A plasma display system includes the following elements:
a panel having a plurality of discharge cells arranged therein, each of the discharge cells having a scan electrode, a sustain electrode, and a data electrode;
a driver circuit; and
a pair of shutter glasses.
   The driver circuit alternately displays a field for a right eye and a field for a left eye on the panel. An image signal for the right eye is displayed in the field for the right eye, and an image signal for the left eye is displayed in the field for the left eye. In each of the field for the right eye and the field for the left eye, a subfield having the smallest luminance weight occurs first, a subfield having the largest luminance weight occurs next, and the other subfields occur thereafter. The driver circuit drives the panel in a manner such that, in the subfield having the smallest luminance weight and the subfield having the largest luminance weight, one-line address operation for applying a scan pulse to each scan electrode is performed, and in the other subfields, two-line simultaneous address operation for applying a scan pulse simultaneously to two adjacent scan electrodes is performed The driver circuit includes a timing signal output part for outputting a timing signal in synchronization with the field for the right eye and the field for the left eye. The pair of shutter glasses opens and closes a right eye shutter and a left eye shutter based on a timing signal output from the timing signal output part.

This configuration stably causes an address discharge while shortening the address period so as to enhance the image display quality when a 3D image is displayed in the plasma display system including the plasma display apparatus usable as a 3D image display apparatus. Thus, a smooth moving 3D image can be displayed on the panel.

### BRIEF DESCRIPTION OF DRAWINGS

FIG. 1 is an exploded perspective view showing a structure of a panel for use in a plasma display apparatus in accordance with an exemplary embodiment of the present invention.

FIG. 2 is an electrode array diagram of the panel for use in the plasma display apparatus in accordance with the exemplary embodiment.

FIG. 3 shows a circuit block diagram of the plasma display apparatus and a diagram outlining a plasma display system in accordance with the exemplary embodiment.

FIG. 4 is a chart of driving voltage waveforms applied to respective electrodes of the panel for use in the plasma display apparatus in accordance with the exemplary embodiment.

FIG. 5 is a schematic diagram showing a subfield structure of the plasma display apparatus and an opening/closing operation of a pair of shutter glasses in accordance with the exemplary embodiment.

FIG. 6 is a schematic diagram showing the subfield structure of the plasma display apparatus, emission luminance in discharge cells, and the opening and closing states of a right eye shutter and a left eye shutter in accordance with the exemplary embodiment.

### DESCRIPTION OF EMBODIMENTS

Hereinafter, a plasma display apparatus in accordance with an exemplary embodiment of the present invention is described, with reference to the accompanying drawings.

### Exemplary Embodiment

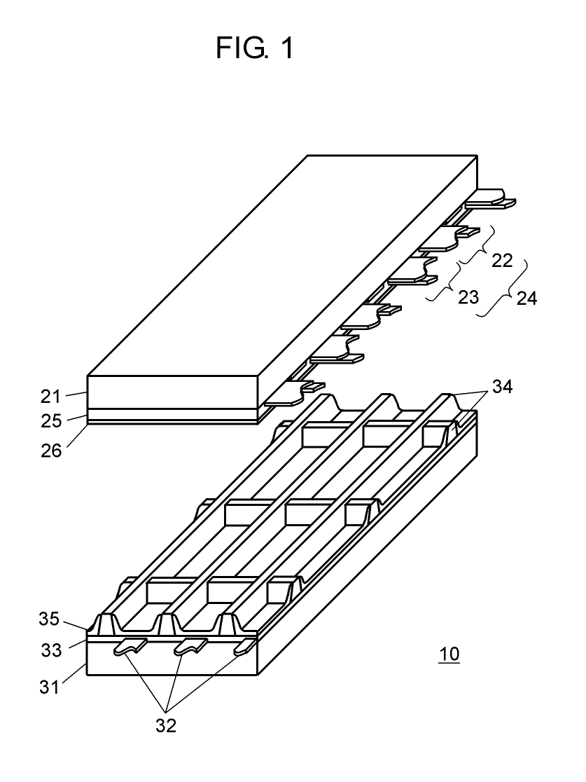

FIG. 1 is an exploded perspective view showing a structure of panel 10 for use in the plasma display apparatus in accordance with the exemplary embodiment of the present invention. A plurality of display electrode pairs 24, each including scan electrode 22 and sustain electrode 23, is disposed on glass front substrate 21. Dielectric layer 25 is formed so as to cover scan electrodes 22 and sustain electrodes 23. Protective layer 26 is formed over dielectric layer 25. Protective layer 26 is made of a material predominantly composed of magnesium oxide (MgO).

A plurality of data electrodes 32 is formed on rear substrate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 for emitting light of red color (R), green color (G), and blue color (B) are formed.

Front substrate 21 and rear substrate 31 face each other such that display electrode pairs 24 intersect data electrodes 32 with a small discharge space sandwiched between the electrodes. The outer peripheries of the substrates are sealed with a sealing material, such as a glass frit. In the inside discharge space, a mixture gas of neon and xenon, for example, is sealed as a discharge gas. In this embodiment, a discharge gas having a xenon partial pressure of approximately 10% is used to enhance emission efficiency.

The discharge space is partitioned into a plurality of compartments by barrier ribs 34. Discharge cells are formed in the intersecting parts of display electrode pairs 24 and data electrodes 32. The discharge cells discharge and emit light (light up) so as to display a color image on panel 10.

In panel 10, three successive discharge cells arranged in the extending direction of display electrode pair 24, i.e. a discharge cell for emitting light of red color (R), a discharge cell for emitting light of green color (G), and a discharge cell for emitting light of blue (B) color, form one pixel.

The structure of panel 10 is not limited to the above, and may include barrier ribs in a stripe pattern, for example. The mixture ratio of the discharge gas is not limited to the above numerical value, and other mixture ratios may be used.

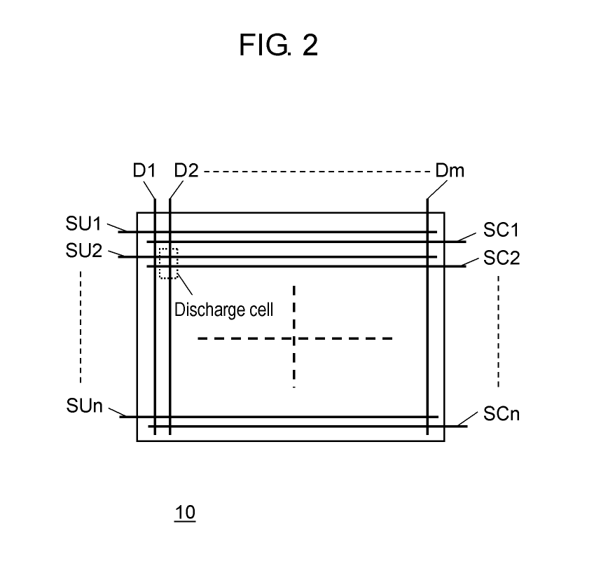

FIG. 2 is an electrode array diagram of panel 10 for use in the plasma display apparatus in accordance with the exemplary embodiment of the present invention. Panel 10 has n scan electrode SC1-scan electrode SCn (scan electrodes 22 in FIG. 1) and n sustain electrode SU1-sustain electrode SUn (sustain electrodes 23 in FIG. 1) both long in the row direction (line direction), and m data electrode D1-data electrode Dm (data electrodes 32 in FIG. 1) long in the column direction. A discharge cell is formed in the part where a pair of scan electrode SCi (i=1−n) and sustain electrode SUi intersects one data electrode Dj (j=1−m). That is, one display electrode pair 24 has m discharge cells, which form m/3 pixels. Then, m×n discharge cells are formed in the discharge space, and the area having m×n discharge cells is the image display area of panel 10. For example, in a panel having 1920×1080 pixels, m=1920×3 and n=1080.

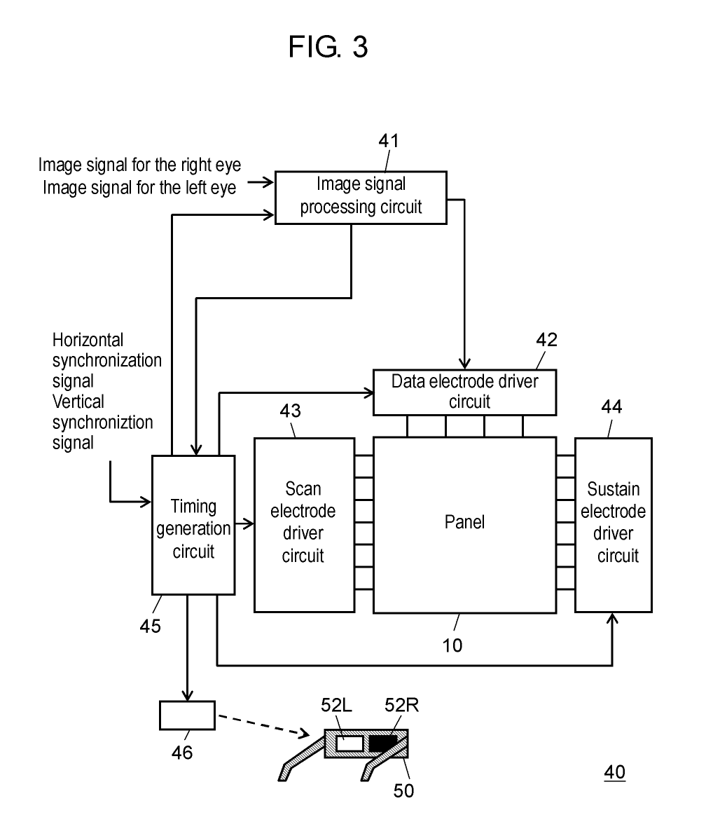

FIG. 3 shows a circuit block diagram of plasma display apparatus 40 and a diagram outlining a plasma display system in accordance with the exemplary embodiment of the present invention. The plasma display system of this exemplary embodiment includes plasma display apparatus 40 and pair of shutter glasses 50 as the elements.

Plasma display apparatus 40 also includes the following elements:
panel 10 having a plurality of discharge cells arranged therein, each of the discharge cells having scan electrode 22, sustain electrode 23, and data electrode 32; and
a driver circuit for driving panel 10.
   The driver circuit includes image signal processing circuit 41; data electrode driver circuit 42; scan electrode driver circuit 43; sustain electrode driver circuit 44; timing generation circuit 45; and electric power supply circuits (not shown) for supplying electric power necessary for each circuit block. Plasma display apparatus 40 includes timing signal output part 46. Timing signal output part 46 outputs a timing signal for opening/closing shutters that controls the opening/closing of the shutters of pair of shutter glasses 50 used by the user.

Image signal processing circuit 41 allocates gradation values to each discharge cell, based on an input image signal. The image signal processing circuit converts the gradation values into image data representing light emission and no light emission in each subfield. For instance, when input image signal sig includes an R signal, a G signal, and a B signal, R, G, and B gradation values are allocated to the respective discharge cells, based on the R signal, G signal, and B signal. When input image signal sig includes a luminance signal (Y signal) and a chroma signal (C signal, R-Y signal and B-Y signal, u signal and v signal, or the like), the R signal, the G signal, and the B signal are calculated based on the luminance signal and the chroma signal, and thereafter the R, G, and B gradation values (gradation values represented in one field) are allocated to the respective discharge cells. Then, the R, G, and B gradation values allocated to the respective discharge cells are converted into image data representing light emission and no light emission in each subfield. When the input image signal is a 3D image signal including an image signal for the right eye and an image signal for the left eye and the 3D image signal is displayed on panel 10, the image signal for the right eye and the image signal for the left eye are alternately input to image signal processing circuit 41 in each field. Thus, image signal processing circuit 41 converts the image signal for the right eye into image data for the right eye, and the image signal for the left eye into image data for the left eye.

Data electrode driver circuit 42 converts the image data for the right eye and the image data for the left eye into signals (address pulses) corresponding to each of data electrode D1-data electrode Dm, and applies the signals to each of data electrode D1-data electrode Dm.

Timing generation circuit 45 generates various timing signals for controlling the operation of each circuit block, based on a horizontal synchronization signal and a vertical synchronization signal, and supplies the generated timing signals to respective circuit blocks (e.g. image signal processing circuit 41, data electrode driver circuit 42, scan electrode driver circuit 43, and sustain electrode driver circuit 44). Timing generation circuit 45 also outputs a timing signal for opening/closing shutters that controls the opening/closing operation of the shutters of pair of shutter glasses 50 to timing signal output part 46. Timing generation circuit 45 sets the timing signal for opening/closing shutters to ON (“1”) when a shutter of pair of shutter glasses 50 opens (in a state of transmitting visible light). The timing generation circuit sets the timing signal for opening/closing shutters to OFF (“0”) when the shutter of pair of shutter glasses 50 closes (in a state of blocking visible light). The timing signals for opening/closing shutters include two types of timing signals: a timing signal (for opening/closing the right eye shutter) that is set to ON in response to a field for the right eye for the display of an image signal for the right eye, and is set to OFF in response to a field for the left eye for the display of an image signal for the left eye; and a timing signal (for opening/closing the left eye shutter) that is set to ON in response to a field for the left eye for the display of an image signal for the left eye, and is set to OFF in response to a field for the right eye for the display of an image signal for the right eye.

Timing signal output part 46 includes a light-emitting element, such as a light-emitting diode (LED), and supplies timing signals for opening/closing shutters to pair of shutter glasses 50 by converting the signals into infrared signals, for example.

Scan electrode driver circuit 43 has an initializing waveform generation circuit, a sustain pulse generation circuit, and a scan pulse generation circuit (not shown). The initializing waveform generation circuit generates an initializing waveform to be applied to scan electrode SC1-scan electrode SCn in the initializing periods. The sustain pulse generation circuit generates a sustain pulse to be applied to scan electrode SC1-scan electrode SCn in the sustain periods. The scan pulse generation circuit has a plurality of scan electrode driver ICs (scan ICs), and generates a scan pulse to be applied to scan electrode SC1-scan electrode SCn in the address periods. Scan electrode driver circuit 43 drives each of scan electrode SC1-scan electrode SCn in response to the timing signals supplied from timing generation circuit 45.

Sustain electrode driver circuit 44 has a sustain pulse generation circuit, and a circuit for generating voltage Ve1 and voltage Ve2 (not shown), and drives sustain electrode SU1-sustain electrode SUn in response to the timing signals supplied from timing generation circuit 45.

Pair of shutter glasses 50 has right eye shutter 52R and left eye shutter 52L. Right eye shutter 52R and left eye shutter 52L can be opened and closed independently. Pair of shutter glasses 50 opens and closes right eye shutter 52R and left eye shutter 52L in response to a timing signal for opening/closing shutters that is supplied from timing signal output part 46. Right eye shutter 52R opens (transmits visible light) when the timing signal for opening/closing the right eye shutter is set to ON, and closes (blocks visible light) when that timing signal is set to OFF. Left eye shutter 52L opens (transmits visible light) when the timing signal for opening/closing the left eye shutter is set to ON, and closes (blocks visible light) when that timing signal is set to OFF. Right eye shutter 52R and left eye shutter 52L can be formed of liquid crystal, for example. However, in the present invention, the material forming the shutters is not limited to liquid crystal. As long as blocking and transmission of visible light can be switched at a high speed, any material may be used.

Next, driving voltage waveforms for driving panel 10 and the operation thereof are outlined. Plasma display apparatus 40 of this embodiment display gradations by a subfield method. In the subfield method, one field is divided into a plurality of subfields along a temporal axis, and a luminance weight is set for each subfield. Then, by controlling the light emission and no light emission in each discharge cell in each subfield, an image is displayed on panel 10.

In this exemplary embodiment, image signals input to plasma display apparatus 40 are 3D image signals, that is, image signals for stereoscopic view where an image signal for the right eye and an image signal for the left eye are alternately repeated in each field. Then, a field for the right eye for the display of an image signal for the right eye and a field for the left eye for the display of an image signal for the left eye are alternately repeated. Thereby, an image for stereoscopic view made of the image for the right eye and the image for the left eye is displayed on panel 10. Further, the user perceives the image for stereoscopic view (3D image) displayed on panel 10 through pair of shatter glasses 50 where right eye shutter 52R and left eye shutter 52L are opened and closed in synchronization with the field for the right eye and the field for the left eye. With this operation, the user can stereoscopically view the 3D image displayed on panel 10.

In the field for the right eye and the field for the left eye, only the signals of the images to be displayed are different. The subfield structure, e.g. the number of subfields forming one field, the luminance weights of the subfields, and the arrangement of the subfields, is identical. First, the structure of one field and the driving voltage waveforms applied to the respective electrodes are described. Hereinafter, when a field “for the right eye” and a field “for the left eye” need not be discriminated, each of the field for the right eye and the field for the left eye is simply referred to as a field, and each of an image signal for the right eye and an image signal for the left eye is also simply referred to as an image signal.

In this exemplary embodiment, in order for the user to view a smooth 3D moving image, the field frequency (the number of fields occurring per second) is set to a frequency (e.g. 120 Hz) twice as high as an ordinary one. This will be detailed later.

Each of the plurality of subfields in each field has an initializing period, an address period, and a sustain period. In this exemplary embodiment, each of the field for the right eye and the field for the left eye is formed of five subfields (subfield SF1, subfield SF2, subfield SF3, subfield SF4, and subfield SF5). Respective subfields have luminance weights of 1, 16, 8, 4, and 2.

In the initializing period, an initializing discharge is caused so as to form wall charge necessary for the subsequent address discharge on the respective electrodes. The initializing operation at this time includes a forced initializing operation and a selective initializing operation. The forced initializing operation forcedly causes initializing discharge in all the discharge cells irrespective of whether a discharge has occurred. The selective initializing operation causes an initializing operation selectively in the discharge cells having undergone an address discharge in the address period of the immediately preceding subfield. Hereinafter, the initializing period where a forced initializing operation is performed is referred to as a forced initializing period. The subfield having a forced initializing period is referred to as “forced initializing subfield”. The initializing period where a selective initializing operation is performed is referred to as a selective initializing period. The subfield having a selective initializing period is referred to as “selective initializing subfield”.

Hereinafter, in this exemplary embodiment, a description is provided for an example where SF1, i.e. a subfield occurring first, in each of a field for the right eye and a field for the left eye is a forced initializing subfield. That is, in the initializing period of subfield SF1, a forced initializing operation is performed. In the initializing periods of the other subfields (subfield SF2-subfield SF5), a selective initializing operation is performed. This structure can cause an initializing discharge in all the discharge cells at least once in one field, thus stabilizing the address operation after the forced initializing operation. Further, the light emission unrelated to image display is only the light emission caused by the discharge in the forced initializing operation in subfield SF1. Thus, luminance of black level, i.e. the luminance of a black display area where no sustain discharge occurs, is reduced. Thereby, an image of high contrast can be displayed on panel 10.

In the address periods, an address pulse is selectively applied to data electrodes 32, and an address discharge is caused so as to form wall charge in the discharge cells to be lit. In this exemplary embodiment, either two-line simultaneous address operation or one-line address operation is performed in the address periods. The two-line simultaneous address operation is an address operation for applying a scan pulse to two adjacent scan electrodes 22 simultaneously. The one-line address operation is an address operation for applying a scan pulse to each electrode 22.

In this exemplary embodiment, in the address period of subfield SF1, which has the smallest luminance weight, and in the address period of SF2, which has the largest luminance weight, the one-line address operation is performed. In the address periods of the other subfields (subfield SF3-subfield SF5), the two-line simultaneous address operation is performed. In this manner, in this exemplary embodiment, in the subfields (subfield SF3-subfield SF5) except the subfield having the smallest luminance weight and the subfield having the largest luminance weight, the two-line simultaneous address operation is performed. This operation shortens the time taken in the address periods.

In the sustain periods, sustain pulses corresponding in number to the luminance weights predetermined for the respective subfields are alternatively applied to display electrode pairs 24. Thereby, sustain discharge is caused in the discharge cells having undergone an address discharge so as to light the discharge cells.

In this exemplary embodiment, as described above, in each of a field for the right eye and a field for the left eye, the luminance weights of the subfields are set as follows. Subfield SF1, which occurs first, is the subfield having the smallest luminance weight (e.g. luminance weight “1”). Subfield SF2, which occurs second, is the subfield having the largest luminance weight (e.g. luminance weight “16”). The subfields thereafter (e.g. subfield SF3-subfield SF5) have the luminance weights sequentially decreasing.

The luminance weight represents a ratio of the magnitudes of luminance displayed in the respective subfields. In the sustain period of each subfield, sustain pulses corresponding in number to the luminance weight are generated. For example, in the sustain period of a subfield having the luminance weight “8”, the number of sustain pulses that is four times the number of sustain pulses in the subfield having the luminance weight “2” is generated, and the number of sustain pulses that is twice the number of sustain pulses in the subfield having the luminance weight “4” is generated. Therefore, the light emission in the subfield having the luminance weight “8” is approximately four times as high as that in the subfield having the luminance weight “2”, and approximately twice as high as that in the subfield having the luminance weight “4”. Therefore, the selective light emission caused by the combination of the respective subfields in response to image signals allows the display of various gradations and an image.

In the sustain period of each subfield, a number of sustain pulses based on the luminance weight of the corresponding subfield multiplied by a predetermined proportionality factor are applied to respective display electrode pairs 24. This proportionality factor is a luminance magnification.

In this exemplary embodiment, when the luminance magnification is 1, four sustain pulses are generated in the sustain period of a subfield having the luminance weight “2”, and two sustain pulses are applied to each of scan electrodes 22 and sustain electrodes 23. That is, in each sustain period, sustain pulses equal in number to the luminance weight of the corresponding subfield multiplied by a predetermined luminance magnification are applied to respective scan electrodes 22 and sustain electrodes 23. Therefore, when the luminance magnification is 2, the number of sustain pulses generated in the sustain period of a subfield having the luminance weight “2” is 8. When the luminance magnification is 3, the number of sustain pulses generated in the sustain period of a subfield having the luminance weight “2” is 12.

However, in this exemplary embodiment, the number of subfields forming one field, or the luminance weights of the respective subfields is not limited to the above values. Alternatively, the subfield structure may be switched in response to an image signal, for example.

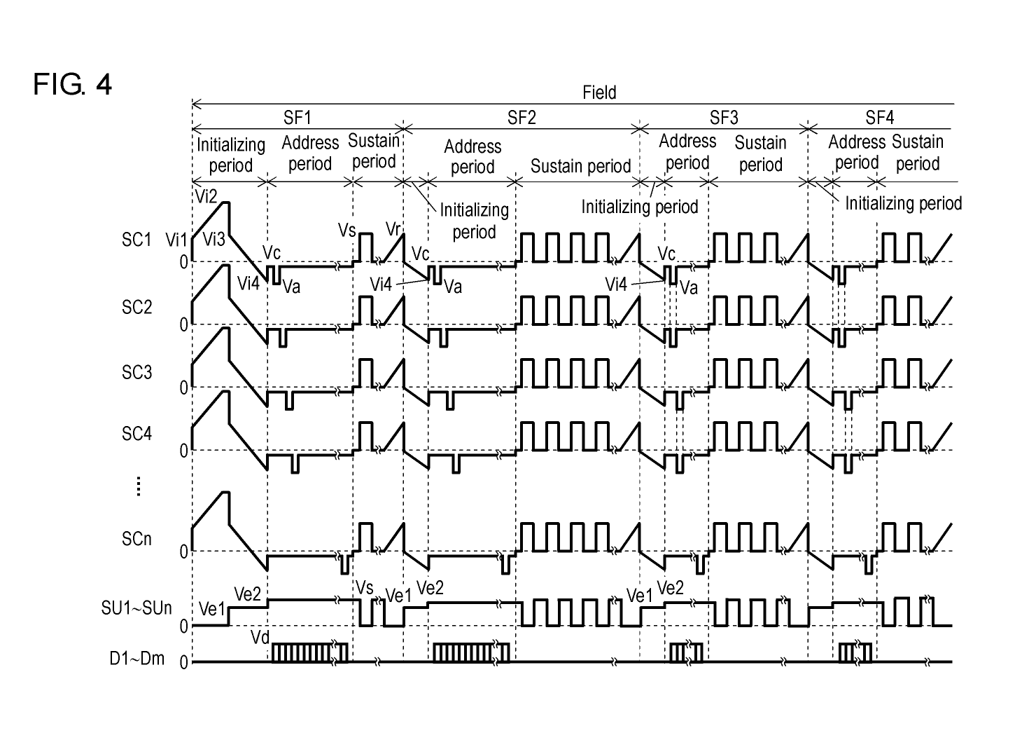

FIG. 4 is a chart of driving voltage waveforms applied to the respective electrodes of panel 10 for use in plasma display apparatus 40 in accordance with the exemplary embodiment of the present invention. FIG. 4 shows driving voltage waveforms applied to the following electrodes: scan electrodes 22 from scan electrode SC1 for undergoing an address operation first in the address periods to scan electrode SC4; scan electrode SCn for undergoing an address operation last in the address periods; sustain electrode SU1-sustain electrode SUn; and data electrode D1-data electrode Dm.

Scan electrode SCi, sustain electrode SUi, and data electrode Dk in the following description are the electrodes selected from the respective electrodes, based on image data (data representing the light emission and no light emission in each subfield).

First, a description is provided for subfield SF1, i.e. a forced initializing subfield having the smallest luminance weight.

In the first half of the initializing period (forced initializing period) of subfield SF1, 0 (V) is applied to data electrode D1-data electrode Dm, and sustain electrode SU1-sustain electrode SUn. Voltage Vi1 is applied to scan electrode SC1-scan electrode SC. Voltage Vi1 is set to a voltage lower than a discharge start voltage with respect to sustain electrode SU1-sustain electrode SUn. Further, a ramp waveform voltage gently rising from voltage Vi1 toward voltage Vi2 is applied to scan electrode SC1-scan electrode SCn. Voltage Vi2 is set to a voltage exceeding the discharge start voltage with respect to sustain electrode SU1-sustain electrode SUn.

While this ramp waveform voltage is rising, a weak initializing discharge continuously occurs between scan electrode SC1-scan electrode SCn and sustain electrode SU1-sustain electrode SUn, and between scan electrode SC1-scan electrode SCn and data electrode D1-data electrode Dm. Then, negative wall voltage accumulates on scan electrode SC1-scan electrode SCn, and positive wall voltage accumulates on data electrode D1-data electrode Dm and sustain electrode SU1-sustain electrode SUn. This wall voltage on the electrodes means voltages that are generated by the wall charge accumulated on the dielectric layers covering the electrodes, the protective layer, the phosphor layers, or the like.

In the second half of the initializing period (forced initializing period), positive voltage Ve1 is applied to sustain electrode SU1-sustain electrode SUn, and 0 (V) is applied to data electrode D1-data electrode Dm. A ramp waveform voltage gently falling from voltage Vi3 to negative voltage Vi4 is applied to scan electrode SC1-scan electrode SCn. Voltage Vi3 is set to a voltage lower than the discharge start voltage with respect to sustain electrode SU1-sustain electrode SUn, and voltage Vi4 is set to a voltage exceeding the discharge start voltage.

While a falling ramp waveform voltage is applied to scan electrode SC1-scan electrode SCn, a weak initializing discharge occurs between scan electrode SC1-scan electrode SCn and sustain electrode SU1-sustain electrode SUn, and between scan electrode SC1-scan electrode SCn and data electrode D1-data electrode Dm. This weak discharge reduces the negative wall voltage on scan electrode SC1-scan electrode SCn and the positive wall voltage on sustain electrode SU1-sustain electrode SU, and adjusts the positive wall voltage on data electrode D1-data electrode Dm to a value appropriate for the address operation. In this manner, the forced initializing operation for forcedly causing an initializing discharge in all the discharge cells is completed.

In the address period of subfield SF1, scan pulse voltage Va is sequentially applied to scan electrode SC1-scan electrode SCn. Positive address pulse voltage Vd is applied to data electrode Dk (k=1−m) corresponding to a discharge cell to be lit among data electrode D1-data electrode Dm. Thus, an address discharge is selectively caused in the respective discharge cells.

Specifically, first, voltage Ve2 is applied to sustain electrode SU1-sustain electrode SUn, and voltage Vc (where voltage Vc=voltage Va+voltage Vsc) is applied to scan electrode SC1-scan electrode SCn.

Next, a scan pulse at negative voltage Va is applied to scan electrode SC1 in the first line. Further, in response to an image signal, an address pulse at positive voltage Vd is applied to data electrode Dk of a discharge cell to be lit in the first line among data electrode D1-data electrode Dm. Thus, the voltage difference in the intersecting part of data electrode Dk and scan electrode SC1 in the discharge cell applied with the address pulse is obtained by adding the difference between the wall voltage on data electrode Dk and the wall voltage on scan electrode SC1 to a difference in externally applied voltage (voltage Vd-voltage Va). Thus, the voltage difference between data electrode Dk and scan electrode SC1 exceeds the discharge start voltage, and a discharge occurs between data electrode Dk and scan electrode SC1.

Since voltage Ve2 is applied to sustain electrode SU1-sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltage Ve2-voltage Va). At this time, setting voltage Ve2 to a voltage value slightly lower than the discharge start voltage can make a state where a discharge is likely to occur but does not actually occurs between sustain electrode SU1 and scan electrode SC1.

With this setting, a discharge occurring between data electrode Dk and scan electrode SC1 can trigger a discharge between the areas of sustain electrode SU1 and scan electrode SC1 intersecting data electrode Dk. Thus, an address discharge occurs in the discharge cell to be lit. Positive wall voltage accumulates on scan electrode SC1, and negative wall voltage accumulates on sustain electrode SU1. Negative wall voltage also accumulates on data electrode Dk.

In this manner, address operation is performed to cause an address discharge in the discharge cells to be lit in the first line and to accumulate wall voltage on the respective electrodes. On the other hand, the voltage in the intersecting parts of scan electrode SC1 and data electrodes 32 applied with no address pulse does not exceed the discharge start voltage, and thus no address discharge occurs.

Next, a scan pulse is applied to scan electrode SC2 in the second line. Further, in response to an image signal, an address pulse is applied to data electrode Dk (k=1−m) of a discharge cell to be lit in the second line. This operation causes an address discharge in a discharge cell to be lit in the second line.

Thereafter, a scan pulse is sequentially applied to scan electrode SC3-scan electrode SCn, and the address operation similar to the above is sequentially repeated until the operation reaches the discharge cells in the n-th line. Thus, the address period is completed. In this manner, in this exemplary embodiment, the one-line address operation is performed in the address period of the subfield having the smallest luminance weight.

In the subsequent sustain period, sustain pulses are alternately applied to display electrode pairs 24. This causes a sustain discharge in the discharge cells having undergone the address discharge, and the discharge cells to emit light.

In this sustain period, first, sustain pulses at positive voltage Vs are applied to scan electrode SC1-scan electrode SCn, and a ground electric potential as a base electric potential, i.e. 0 (V), is applied to sustain electrode SU1-sustain electrode SUn. Then, in the discharge cells having undergone the address discharge, the voltage difference between scan electrode SCi and sustain electrode SUi is obtained by adding the difference between the wall voltage on scan electrode SCi and the wall voltage on sustain electrode SUi to sustain pulse voltage Vs.

Thus, the voltage difference between scan electrode SCi and sustain electrode SUi exceeds the discharge start voltage and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, voltage 0 (V) as the base electric potential is applied to scan electrode SC1-scan electrode SCn, and sustain pulses are applied to sustain electrode SU1-sustain electrode SUn. In the discharge cells having undergone the sustain discharge, the voltage difference between sustain electrode SUi and scan electrode SCi exceeds the discharge start voltage. Thereby, a sustain discharge occurs between sustain electrode SUi and scan electrode SCi again. Negative wall voltage accumulates on sustain electrode SUi, and positive wall voltage accumulates on scan electrode SCi.

Similarly, sustain pulses are alternately applied to scan electrode SC1-scan electrode SCn and sustain electrode SU1-sustain electrode SUn. Thereby, the sustain discharge is continued in the discharge cells having undergone the address discharge in the address period.

The number of sustain pulses generated in each sustain period is a number based on the luminance weight of the corresponding subfield multiplied by a predetermined luminance magnification. A number of sustain pulses corresponding in number to the luminance weight multiplied by a luminance magnification are applied to respective scan electrodes 22 and sustain electrodes 23. However, in this exemplary embodiment, in the sustain period of subfield SF1, sustain pulses larger in number than the luminance weight multiplied by the luminance magnification are applied to respective scan electrodes 22 and sustain electrodes 23. The reason for this is described later.

After the sustain pulses have been generated in the sustain period, a ramp waveform voltage gently rising from 0 (V) toward voltage Vr is applied to scan electrode SC1-scan electrode SCn while 0 (V) is applied to sustain electrode SU1-sustain electrode SUn and data electrode D1-data electrode Dm. Voltage Vr set to a voltage exceeding the discharge start voltage causes a weak discharge between sustain electrode SUi and scan electrode SCi in the discharge cell having undergone a sustain discharge. The charged particles generated by this weak discharge accumulate on sustain electrode SUi and scan electrode SCi so as to reduce the voltage difference between sustain electrode SUi and scan electrode SCi. Thereby, in the discharge cells having undergone the sustain discharge, a part or the whole of the wall voltage on scan electrode SCi and sustain electrode SUi is erased while the positive wall charge is left on data electrode Dk.

After the rising voltage has reached voltage Vr, the voltage applied to scan electrode SC1-scan electrode SCn is lowered to voltage 0 (V). Thus, the sustain operation in the sustain period is completed.

Next, a description is provided for subfield SF2, i.e. a selective initializing subfield having the largest luminance weight.

In the initializing period of subfield SF2, voltage Ve1 is applied to sustain electrode SU1-sustain electrode SUn, and 0 (V) is applied to data electrode D1-data electrode Dm. A ramp waveform voltage gently falling from a voltage (e.g. voltage 0 (V)) lower than the discharge start voltage toward negative voltage Vi4 exceeding the discharge start voltage is applied to scan electrode SC1-scan electrode SCn.

With this voltage application, a weak initializing discharge occurs in the discharge cells having undergone a sustain discharge in the sustain period of the immediately preceding subfield (subfield SF1 in FIG. 4). This weak discharge reduces the wall voltage on scan electrode SCi and sustain electrode SUi. Since sufficient positive wall voltage is accumulated on data electrode Dk by the immediately preceding sustain discharge, the excess part of this wall voltage is discharged and is adjusted to a value appropriately for the address operation.

In contrast, in the discharge cells having undergone no sustain discharge in the sustain period of the immediately preceding subfield, no initializing discharge occurs, and the wall discharge at the completion of the initializing period of the immediately preceding subfield is maintained. In this manner, in the initializing operation in subfield SF2, a selective initializing operation is performed so as to cause an initializing discharge in the discharge cells having undergone an address operation in the address period of the immediately preceding subfield, i.e. in the discharge cells having undergone a sustain discharge in the sustain period of the immediately preceding subfield.

In the address period of subfield SF2, voltage Ve2 is applied to sustain electrode SU1-sustain electrode SUn, and voltage Vc is applied to scan electrode SC1-scan electrode SCn.

Next, a scan pulse is applied to scan electrode SC1 in the first line. Further, in response to an image signal, an address pulse is applied to data electrode Dk of a discharge cell to be lit in the first line so as to cause an address discharge in the discharge cell to be lit in the first line. Next, a scan pulse is applied to scan electrode SC2 in the second line. Further, in response to an image signal, an address pulse is applied to data electrode Dk of a discharge cell to be lit in the second line so as to cause an address discharge in the discharge cells to be lit in the second line.

Thereafter, a scan pulse is sequentially applied to scan electrode SC3-scan electrode SCn, and the address operation similar to the above is sequentially repeated until the operation reaches the discharge cells in the n-th line. Thus, the address period is completed. In this manner, in this exemplary embodiment, the one-line address operation is performed in the address period of the subfield having the largest luminance weight.

In the sustain period of subfield SF2, sustain pulses corresponding in number to the luminance weight multiplied by a predetermined luminance magnification are alternately applied to scan electrode SC1-scan electrode SC1 and sustain electrode SC1-sustain electrode SCn so as to continuously cause a sustain discharge in the discharge cells having undergone the address discharge in the address period. At the end of the sustain period, a ramp waveform voltage gradually rising toward voltage Vr is applied to scan electrode SC1-scan electrode SCn.

The operation in the initializing period of subfield SF3 is similar to the operation of the initializing period of subfield SF2, and thus the description is omitted.

In the address period of subfield SF3, voltage Ve2 is applied to sustain electrode SU1-sustain electrode SUn, and voltage Vc is applied to scan electrode SC1-scan electrode SCn.

Next, a scan pulse is applied simultaneously to scan electrode SC1 in the first line and scan electrode SC2 in the second line. Further, in response to an image signal, an address pulse is applied to data electrode Dk of a discharge cell to be lit in the first line among data electrode D1-data electrode Dm.

Thus, the voltage difference in the intersecting part of data electrode Dk and scan electrode SC1 and the voltage difference in the intersecting part of data electrode Dk and scan electrode SC2 in the discharge cells applied with the address pulse exceed the discharge start voltage. Thus, a discharge occurs between data electrode Dk and scan electrode SC1, and between data electrode Dk and scan electrode SC2. Further, the discharge occurring between data electrode Dk and scan electrode SC1 triggers a discharge between the areas of sustain electrode SU1 and scan electrode SC1 intersecting data electrode Dk, and the discharge occurring between data electrode Dk and scan electrode SC2 triggers a discharge between the areas of sustain electrode SU2 and scan electrode SC2 intersecting data electrode Dk.

In this manner, an address discharge is caused in the discharge cells to be lit. Positive wall voltage accumulates on scan electrode SC1 and scan electrode SC2. Negative wall voltage accumulates on sustain electrode SU1 and sustain electrode SU2. Negative wall voltage also accumulates on data electrode Dk.

In this manner, the address discharge is caused in the discharge cell to be lit in the second line in addition to the discharge cell to be lit in the first line. On the other hand, the voltage in the intersecting parts of data electrodes 32 applied with no address pulse and scan electrode SC1, and in the intersecting parts of data electrodes 32 applied with no address pulse and scan electrode SC2 does not exceed the discharge start voltage. Thus, no address discharge occurs.

Next, a scan pulse is applied simultaneously to scan electrode SC3 in the third line and scan electrode SC4 in the fourth line. Further, in response to an image signal, an address pulse is applied to data electrode Dk of a discharge cell to be lit in the third line among data electrode D1-data electrode Dm. In this manner, an address operation is performed in the discharge cell to be lit in the fourth line in addition to the discharge cell to be lit in the third line.

Hereinafter, an address operation is repeated until the operation reaches scan electrode SCn in the following manner. A scan pulse is applied simultaneously to scan electrode SCp (p=an odd number) in an odd-numbered line and scan electrode SCp+1 in the next even-numbered line. In response to an image signal, an address pulse is applied to data electrode Dk of the discharge cell to be lit in the p-th line among data electrode D1-data electrode Dm.

In this exemplary embodiment, in this manner, the two-line simultaneous address operation is performed in the address period of subfield SF3. With this operation, in subfield SF3, only the image signals in the odd-numbered lines are displayed. The discharge cells in the two adjacent lines, i.e. a discharge cell in an odd-numbered line and a discharge cell in an even-numbered line, are lit in the same pattern. This can reduce the time taken for the address operation to approximately a half of that taken in the one-line addressing.

In this exemplary embodiment, the combination of scan electrodes 22 for undergoing the two-line simultaneous address operation is changed in every two fields. For instance, when the two-line simultaneous address operation is performed in field for the right eye Fn and subsequent field for the left eye Fn+1, a scan pulse is applied simultaneously to scan electrode SCp in an odd-numbered line and scan electrode SCp+1 in the next even-numbered line, and an address operation is performed by applying an address pulse to data electrode Dk of the discharge cell to be lit in the p-th line, in response to an image signal. In that case, when the two-line simultaneous address operation is performed on field for the right eye Fn+2 and field for the left eye Fn+3, a scan pulse is applied simultaneously to scan electrode SCp+1 in an even-numbered line and scan electrode SCp+2 in the next odd-numbered line, and the two-line simultaneous address operation is performed by applying an address pulse to data electrode Dk of the discharge cell to be lit in the (p+1)-th line, in response to an image signal.

In the sustain period of subfield SF3, sustain pulses equal in number to the luminance weight multiplied by a predetermined luminance magnification are alternately applied to scan electrode SC1-scan electrode SCn and sustain electrode SC1-sustain electrode SCn so as to continuously generate a sustain discharge in the discharge cells having undergone the address discharge in the address period. At the end of the sustain period, a ramp waveform voltage gradually rising toward voltage Vr is applied to scan electrode SC1-scan electrode SCn.

The operation in the initializing periods of subsequent subfield SF4 and subfield SF5 is a selective initializing operation similar to that of the initializing period of subfield SF3. The operation in the address periods of subfield SF4 and subfield SF5 is a two-line simultaneous address operation similar to the operation in subfield SF3. Further, the operation in the sustain periods of subfield SF4 and subfield SF5 is similar to the operation of that in subfield SF3 except for the number of sustain pulses.

The above description has outlined the driving voltage waveforms applied to the respective electrodes of panel 10 in this exemplary embodiment.

The voltage to be applied to the respective electrodes in this exemplary embodiment includes the following values: voltage Vi1=145 (V); voltage Vi2=335 (V); voltage Vi3=190 (V); voltage Vi4=−160 (V); voltage Va=−180 (V); voltage Vc=−35 (V); voltage Vs=190 (V); voltage Vr=190 (V); voltage Ve1=125 (V); voltage Ve2=130 (V); and voltage Vd=60 (V). However, these voltage values are only examples. Preferably, each of the voltage values is set appropriate for the characteristics of panel 10, the specifications of plasma display apparatus 40, or the like. For example, voltage Ve1 and voltage Ve2 may be equal, and voltage Vc may be at a positive value.

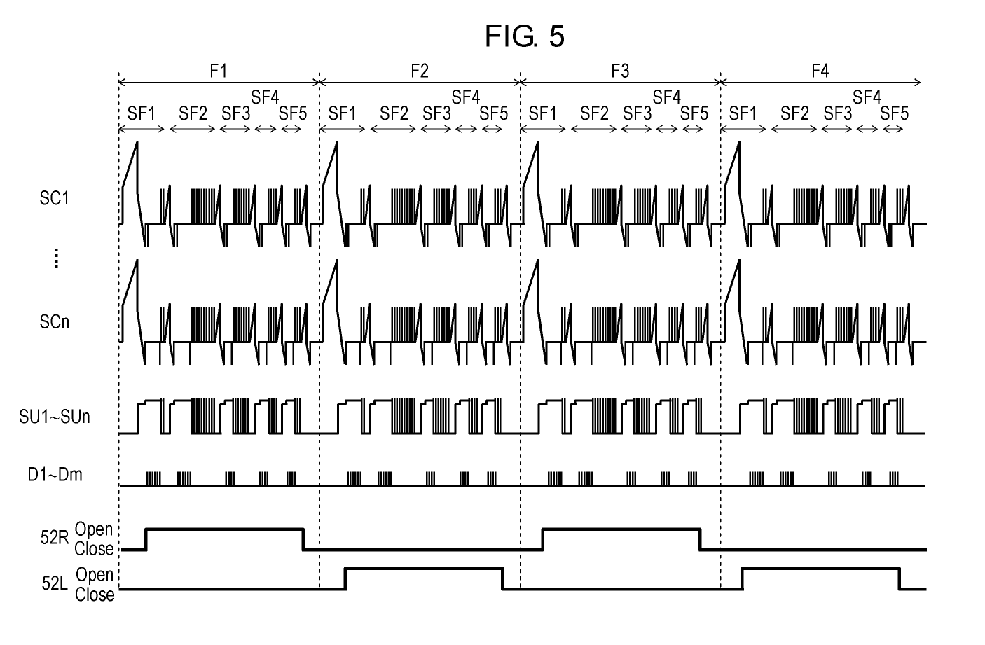

Next, the subfield structure of plasma display apparatus 40 of this exemplary embodiment is described again. FIG. 5 is a schematic diagram showing a subfield structure of plasma display apparatus 40 and an opening/closing operation of pair of shutter glasses 50 in accordance with the exemplary embodiment of the present invention. FIG. 5 shows driving voltage waveforms applied to scan electrode SC1 for undergoing an address operation first in the address periods, scan electrode SCn for undergoing an address operation last in the address periods, sustain electrode SU1-sustain electrode SUn, and data electrode D1-data electrode Dm, together with an opening/closing operation of right eye shutter 52R and left eye shutter 52L. FIG. 5 also shows four fields (field F1-field F4).

In this exemplary embodiment, in order to display a 3D image on panel 10, a field for the right eye and a field for the left eye are alternately generated. For example, among four fields shown in FIG. 5, field F1 and field F3 are fields for the right eye, where an image signal for the right eye is displayed on panel 10. Field F2 and field F4 are fields for the left eye, where an image signal for the left eye is displayed on panel 10. The user who views a 3D image displayed on panel 10 through pair of shutter glasses 50 perceives images shown in two fields (an image for the right eye and an image for the left eye) as one 3D image. Thus, the user perceives the number of images displayed on panel 10 per second as a half the number of fields displayed per second. For instance, when the field frequency of 3D images displayed on panel (the number of fields generated per second) is 60 Hz, the user perceives thirty 3D images per second. Therefore, in order to display sixty 3D images per second, the field frequency needs to be set to 120 Hz, which is twice of 60 Hz. Then, in this exemplary embodiment, the field frequency (the number of fields generated per second) is set to twice (e.g. 120 Hz) the ordinary field frequency so that the user can perceive a smooth 3D moving image.

The opening/closing operation of right eye shutter 52R and left eye shutter 52L of pair of shutter glasses 50 is controlled in response to the ON/OFF of the shutter opening/closing timing signal output from timing signal output part 46. That is, timing generation circuit 45 generates timing signals for opening/closing shutters (a timing signal for opening/closing the right eye shutter and a timing signal for opening/closing the left eye shutter) and outputs the timing signals from timing signal output part 46 to pair of shutter glasses 50 in the following manner. In fields for the right eye (e.g. field F1 and field F3), right eye shutter 52R opens and left eye shutter 52L closes, and in fields for the left eye (e.g. field F2 and field F4), left eye shutter 52L opens and right eye shutter 52R closes. These operations are detailed later.

Each of the field for the right eye and the field for the left eye is formed of five subfields (SF1, SF2, SF3, SF4, and SF5). Respective subfields have luminance weights of 1, 16, 8, 4, and 2. The reason why each subfield is set as above is described below.

Phosphor layers 35 have afterglow characteristics depending on the materials making up the phosphors. The afterglow is a phenomenon such that the phosphor maintains light emission even after the completion of discharge. As the phosphor emits light at higher luminance, the afterglow is stronger. The afterglow has a time constant corresponding to the characteristic of the phosphor. In response to the time constant, the emission luminance gradually attenuates with a lapse of time. For this reason, the time taken for attenuation increases as the luminance at which the phosphor emits light increases.

The light emission in a subfield having a larger luminance weight causes an emission luminance higher than that of the light emission in a subfield having a smaller luminance weight. Therefore, the afterglow caused by the light emission in a subfield having a large luminance weight has a higher luminance and takes a longer attenuation time than the afterglow caused by the light emission in a subfield having a smaller luminance weight.

For this reason, if the last subfield of one field is a subfield having a large luminance weight, the afterglow leaking into the subsequent field is larger than that when the last subfield is a subfield having a small luminance weight. In plasma display apparatus 40 for displaying a 3D image on panel 10 by alternately generating a field for the right eye and a field for the left eye, when the afterglow generated in one field leaks into the subsequent field, the afterglow is perceived by the user as unnecessary light emission unrelated to an image signal. This phenomenon is crosstalk. Higher crosstalk inhibits the stereoscopic view and degrades the image display quality.

The crosstalk can be reduced in the following manner. A subfield having a large luminance weight is generated in an earlier time of one field so as to allow the strong afterglow to settle in that field. Then, the luminance weight is sequentially reduced and the last subfield of one field is set to a subfield having a small luminance weight such that the leak of the afterglow into the next field is minimized.

On the other hand, in this exemplary embodiment, in order to reduce the luminance of black level and stabilize the address discharge, subfield SF1 is set to a forced initializing subfield and the other subfields to selective initializing subfields. Therefore, in the initializing period of subfield SF1, an initializing discharge can be caused in all the discharge cells so as to generate wall charge and priming particles necessary for the address operation. However, this wall charge and priming particles are gradually lost with a lapse of time.

For example, the wall charge and priming particles in the last subfield (e.g. subfield SF5) of one field are compared between a discharge cell for undergoing address operation in intermediate subfields (e.g. any one of or a plurality of subfield SF1-subfield SF4) and a discharge cell for undergoing no address operation in the intermediate subfields. In this case, the wall charge and priming particles are less in the discharge cells undergoing no address operation in the intermediate subfields. In the discharge cells undergoing address operation in the intermediate subfields, a sustain discharge is caused by the address operation, which generates wall charge and priming particles. In contrast, in the discharge cells undergoing no address operation in the intermediate subfields, no sustain discharge occurs after the initializing operation in subfield SF1 immediately before the last subfield. Thus, there is no opportunity to generate wall charge and priming particles. As a result, the wall charge and priming particles in the discharge cells reduce more.

In the subfield having the largest luminance weight, a sustain discharge occurs in discharge cells displaying bright gradations but no sustain discharge occurs in discharge cells displaying dark gradations. For example, when an image in a dark pattern is displayed on panel 10, no sustain discharge occurs in a subfield having the largest luminance weight in some cases. It is experimentally verified that the number of lit discharge cells is larger in a subfield having a smaller luminance weight in a generally viewed moving image. For this reason, when a typical moving image is displayed on panel 10, the probability of occurrence of a sustain discharge in the subfield having the smallest luminance weight is higher than the probability of occurrence of a sustain discharge in the subfield having the largest luminance weight, which depends on the pattern of the image. That is, the probability of occurrence of a sustain discharge in the subfield having the largest luminance weight is lower than the probability of occurrence of a sustain discharge in the subfield having the smallest luminance weight.

Therefore, in a structure where the luminance weight of subfield SF1 is the largest and the luminance weight is sequentially reduced toward the last subfield, the probability of occurrence of a sustain discharge in subfield SF1 is low. Thus, in an increased number of discharge cells, the address operation in the last subfield can be unstable.

Then, in this exemplary embodiment, the structure is set such that subfield SF1 is a subfield having the smallest luminance weight, subfield SF2 is a subfield having the largest luminance weight, and subfield SF3 and thereafter have luminance weights sequentially decreasing.

This structure can make the number of discharge cells for undergoing a sustain discharge in subfield SF1 larger than that in a structure where the luminance weight is sequentially decreased from subfield SF1 toward the last subfield.

When a sustain discharge occurs in subfield SF1, the sustain discharge can replenish the wall charge and priming particles in the discharge cells. Thus, the address operation in the last subfield can be more stabilized.

Subfield SF1 is a forced initializing subfield. Thus, in subfield SF1, while the priming generated in the forced initializing operation is remaining, an address discharge can be caused, thus allowing a stable address operation. Therefore, even in discharge cells to be lit only in the subfield having the smallest luminance weight, a stable address discharge can be caused.

Further, since a subfield having a large luminance weight can be generated in an earlier time of one field, the magnitude of the afterglow can be sequentially reduced in subfield SF3 or thereafter, and the leak of the afterglow into the next field, i.e. crosstalk, can be reduced.

That is, in plasma display apparatus 40 of this exemplary embodiment, the address operation in the last subfield can be stabilized in addition to the above reduction of crosstalk.

In this exemplary embodiment, in the address periods of subfield SF1 and subfield SF2 in each field, one-line address operation is performed. In the address periods of subfield SF3-subfield SF5, two-line simultaneous address operation is performed.

At this time, in the address periods of subfield SF3-subfield SF5 in field F1, i.e. a field for the right eye, two-line simultaneous address operation is performed in the following manner. A scan pulse is applied simultaneously to scan electrode SCp in an odd-numbered line and scan electrode SCp+1 in the next even-numbered line, and in response to an image signal, an address pulse is applied to data electrode Dk of the discharge cell to be lit in the p-th line.

In the address periods of subfield SF3-subfield SF5 in field F3, i.e. the next field for the right eye, two-line simultaneous address operation is performed in the following manner. A scan pulse is applied simultaneously to scan electrode SCp+1 in an even-numbered line and scan electrode SCp+2 in the next odd-numbered line, and in response to an image signal, an address pulse is applied to data electrode Dk of the discharge cell to be lit in the (p+1)-th line.

In the address periods of subfield SF3-subfield SF5 in field F2, i.e. a field for the left eye, the two-line simultaneous address operation is performed in the following manner. A scan pulse is applied simultaneously to scan electrode SCp in an odd-numbered line and scan electrode SCp+1 in the next even-numbered line, and in response to an image signal, an address pulse is applied to data electrode Dk of the discharge cell to be lit in the p-th line.

In the address periods of subfield SF3-subfield SF5 in field F4, i.e. the next field for the left eye, the two-line simultaneous address operation is performed in the following manner. A scan pulse is applied simultaneously to scan electrode SCp+1 in an even-numbered line and scan electrode SCp+2 in the next odd-numbered line, and in response to an image signal, an address pulse is applied to data electrode Dk of the discharge cell to be lit in the (p+1)-th line.

In this exemplary embodiment, by repeating the above operation of field F1 through field F4 similarly in the succeeding fields, a 3D image is displayed on panel 10.

In this manner, in this exemplary embodiment, in the address periods of subfield SF1 having the smallest luminance weight and subfield SF2 having the largest luminance weight, the one-line address operation is performed. In the address periods of subfield SF3 and thereafter, the two-line simultaneous address operation is performed. Next, the reason for this is described.

As described above, the conventional driving method using the simultaneous address operation can shorten the address period, and thus is an effective driving method for shortening the time taken for displaying images. However, this driving method has the following problem. In one image displayed on panel 10, each discharge cell formed on two adjacent scan electrodes 22 emit light in the same pattern, and thus the vertical resolution tends to degrade. Especially when a moving image is displayed on panel 10, image degradation caused by a decrease in the vertical resolution is conspicuous.

Then, in this exemplary embodiment, in the address period of subfield SF2, the one-line address operation is performed. Subfield SF2 is a subfield that has the largest luminance weight, and has a key role in displaying the contour of a pattern in a display image. Therefore, the one-line address operation is performed in the address period of subfield SF2. Thereby, the discharge cells in each line can be lit in a pattern in response to an image signal, and the degradation of the vertical resolution in the contour of the display image can be suppressed in a subfield having the largest luminance weight.

As described above, a 3D image is formed of two images for the right eye and the left eye. Thus, when a 3D image is displayed on panel 10, the number of 3D images displayed per second is a half the field frequency. Therefore, in order to display 3D images equal in number (per second) to conventional images (2D images), the time of one field needs to be made a half of that of a conventional image so as to double the field frequency.

When the time of one field is shortened, the number of subfields forming one field needs to be reduced. Thereby, the number of gradations displayable on panel 10 is reduced. In order to make up for the reduced gradations and to display more gradations in a fewer subfields, image processing for displaying gradations in a pseudo manner, e.g. a dither method and an error diffusion method, is effective. In these image processing methods, light emission in a subfield having the smallest luminance weight plays an important role.

Then, in this exemplary embodiment, the one-line address operation is performed in the address period of subfield SF1 having the smallest luminance weight. With this operation, in a subfield having the smallest luminance weight, the discharge cells in each line can be lit in different patterns. This can prevent a decrease in the effect of image signal processing, e.g. a dither method and an error diffusion method. Therefore, the gradations of even an image having a low luminance can be displayed smoothly.

In the above driving method, the time taken in the address periods of subfield SF1 and subfield SF2 is longer than the time taken in the address periods of subfield SF3-subfield SF5. This can enhance the advantage of suppressing crosstalk.

Next, a description is provided for the subfield structure for driving plasma display apparatus 40 in this exemplary embodiment, with the opening/closing operation of shutters of pair of shutter glasses 50.

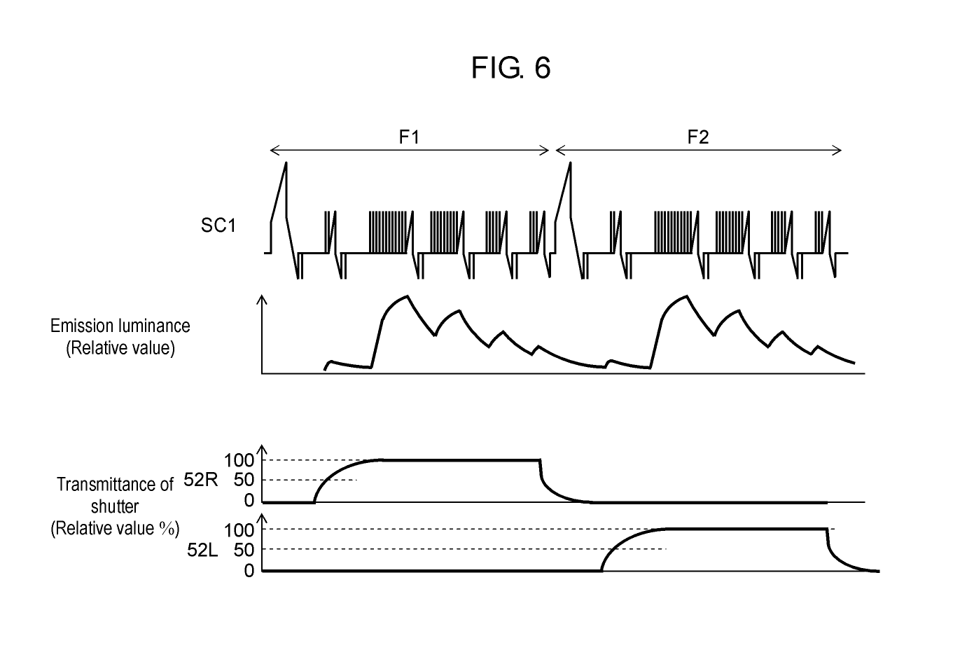

FIG. 6 is a schematic diagram showing the subfield structure of plasma display apparatus 40, emission luminance in discharge cells, and the opening and closing states of right eye shutter 52R and left eye shutter 52L in accordance with the exemplary embodiment of the present invention. FIG. 6 shows driving voltage waveforms to be applied to scan electrode SC1, waveforms showing emission luminance (relative values), and opening and closing states of right eye shutter 52R and left eye shutter 52L of pair of shutter glasses 50. FIG. 6 shows two fields (field F1 for the right eye and field F2 for the left eye).

In the drawing showing emission luminance in FIG. 6, the emission luminance is shown in a relative manner. The value in a higher position along the vertical axis shows a higher emission luminance. In the drawing showing the opening and closing states of the shutter, the opening and closing states of right eye shutter 52R and left eye shutter 52L are shown with a transmittance. Along the vertical axis, the transmittance of the shutter is relatively shown with a transmittance of the shutter in the completely opened state (a maximum transmittance) as 100% and a transmittance of the shutter in the completely closed state (a minimum transmittance) as 0%. In each waveform chart of FIG. 6, the horizontal axis shows time.

Phosphor layers 35 for use in panel 10 have afterglow characteristics depending on the materials making up the phosphors. For example, there is a phosphor material that has characteristics of maintaining afterglow for several milliseconds even after the completion of a sustain discharge. When the afterglow generated in one field leaks into the subsequent field, the afterglow is perceived by the user as crosstalk. For instance, if an image for the left eye is displayed on panel 10 after the field for the display of an image for the right eye has completed and before the persistence of vision caused by the afterglow of the image for the right eye disappears, crosstalk of entry of an image for the right eye into the image for the left eye occurs. If the luminance of the afterglow and thus the crosstalk increase, the stereoscopic view is inhibited. As a result, the image display quality in plasma display apparatus 40 is degraded. This image display quality is the image display quality for the user who views a 3D image through pair of shutter glasses 50.

At this time, for instance, this crosstalk can be reduced by opening left eye shutter 52L (right eye shutter 52R) after the afterglow of the image for the right eye (the image for the left eye) is sufficiently attenuated.

In this exemplary embodiment, the time taken for the address periods of subfield SF1 and subfield SF2 is longer than the time taken for the address periods of subfield SF3-subfiled SF5. Therefore, the time from the completion of the immediately preceding field to the start of the sustain period of subfield SF2 is longer than that of the other subfields. During this period, the afterglow generated in the immediately preceding field can be sufficiently attenuated. If the timing signals for opening/closing the shutters are output from timing signal output part 46 to pair of shutter glasses 50 such that the shutters (left eye shutter 52L and right eye shutter 52R) are completely opened immediately before the sustain period of subfield SF2, entry of this afterglow into the eyes of the user can be prevented without blocking the light emission in subfield SF2 and crosstalk can be reduced.

In pair of shutter glasses 50, time corresponding to the characteristics of the materials (e.g. liquid crystal) making up the shutters is taken after the shutter starts to close and before it completely closes, or after the shutter starts to open and before it completely opens. Pair of shutter glasses 50 takes approximately 0.5 msec, for example, after the shutter starts to close and before it completely closes (the transmittance of the shutter changes from 100% to 10%, for example). The pair of shutter glasses takes approximately 2 msec, for example, after the shutter starts to open and before it completely opens (the transmittance of the shutter changes from 0% to 90%, for example).

In this exemplary embodiment, with these facts taken into account, the opening/closing timings of right eye shutter 52R and left eye shutter 52L are set.

That is, in a field for the right eye (e.g. field F1 and field F3), timing generation circuit 45 generates the timing signal for opening/closing the shutters (a timing signal for opening/closing the right eye shutter) and outputs the timing signal from timing signal output part 46 to pair of shutter glasses 50 in the following manner. Right eye shutter 52R starts to open before the start of the sustain period of subfield SF1 and right eye shutter 52R completely opens immediately before the start of the sustain period of subfield SF2. Then, right eye shutter 52R starts to close after the generation of the sustain pulses in the sustain period of subfield SF5, i.e. the last subfield.

In a field for the left eye (e.g. field F2 and field F4), the timing generation circuit generates the timing signal for opening/closing the shutters (a timing signal for opening/closing the left eye shutter) and outputs the timing signal from timing signal output part 46 to pair of shutter glasses 50 in the following manner. Left eye shutter 52L starts to open before the start of the sustain period of subfield SF1 and left eye shutter 52L opens completely immediately before the start of the sustain period of subfield SF2. Then, left eye shutter 52L starts to close after the generation of the sustain pulses in the sustain period of subfield SF5, i.e. the last subfield.

The similar operation is repeated in the succeeding fields. This operation can reduce crosstalk and thus improve the image display quality. Thereby, an excellent stereoscopic view is achieved in plasma display apparatus 40.

However, when the opening/closing of the shutters of pair of shutter glasses 50 is controlled in this manner, in the sustain period of subfield SF1, the shutter corresponding to the image to be displayed in that field (left eye shutter 52L or right eye shutter 52R) is in the state of gradually opening, and the transmittance is lower than 100%.

For instance, when the transmittance in the sustain period of subfield SF1 is 50%, the user who views a 3D image through pair of shutter glasses 50 perceives that the light emission in subfield SF1 is at a half the original luminance.

Therefore, in this exemplary embodiment, the number of sustain pulses generated in the sustain period of subfield SF1 is corrected based on the transmittance of the shutter. Specifically, the luminance weight of subfield SF1 is multiplied by a predetermined luminance magnification, and further multiplied by the inverse number of the transmittance of the shutter. In this manner, the number of sustain pulses generated in the sustain period of subfield SF1 is determined. For instance, when the luminance weight of subfield SF1 is “1”, the luminance magnification is “1”, and the transmittance of the shutter in the sustain period of subfield SF1 is 50%, four sustain pulses are generated in the sustain period of subfield SF1, and the sustain pulse is applied twice to scan electrodes 22 and sustain electrodes 23.

Thus, even when the transmittance of the shutter is lower than 100% in the sustain period of subfield SF1, the user who views a 3D image through pair of shutter glasses 50 can perceive the emission luminance corresponding to luminance weight “1” in the sustain period of subfield SF1. Therefore, when a 3D image is displayed on panel 10, gradations can be displayed precisely while crosstalk is suppressed.

The transmittance of the shutter is a transmittance of the shutter (left eye shutter 52L or right eye shutter 52R) corresponding to the image displayed in the field.

The above description of “the shutter completely closes” means that the transmittance of the shutter is equal to or lower than 10%. The above description of “the shutter completely opens” means that the transmittance of the shutter is equal to or higher than 90%.

In this exemplary embodiment, in either of a field for the right eye and a field for the left eye, right eye shutter 52R and left eye shutter 52L of pair of shutter glasses 50 are both in the closed state in the initializing period (forced initializing period) of a forced initializing subfield (subfield SF1). That is, the light emission caused by the forced initializing operation is blocked by right eye shutter 52R and left eye shutter 52L, and does not enter the eyes of the user. Thus, the user who views a 3D image through pair of shutter glasses 50 cannot see the light emission caused by the forced initializing operation, and the luminance of black level is reduced by the luminance of the light emission. In this manner, in this exemplary embodiment, the user can view an image of high contrast at reduced luminance of black level.

In the example of the structure described in this exemplary embodiment, each of the field for the right eye and the field for the left eye is formed of five subfields. However, the number of subfields in the present invention is not limited to the above numerical values. If the number of subfields is increased to six or larger, for example, the number of gradations displayable on panel 10 can be further increased. The number of subfields forming each field may be set appropriately for the specifications of plasma display apparatus 40, for example.

In the example described in this exemplary embodiment, the luminance weights of the subfields are powers of “2” and the luminance weights of the respective subfields are 1, 16, 8, 4, and 2, for example. However, the luminance weights in the present invention are not limited to the above numerical values. Setting the luminance weights of respective subfields to 1, 12, 7, 3, and 2, for example, gives redundancy to the combination of the subfields determining gradations and allows the coding for suppressing the generation of the moving image false contour.

The driving voltage waveforms in FIG. 4 only show an example in the exemplary embodiment of the present invention. The present invention is not limited to these driving voltage waveforms.

Each circuit block shown in the exemplary embodiment of the present invention may be formed as an electric circuit that performs each operation shown in the exemplary embodiment, or formed of a microcomputer programmed so as to perform the similar operation, for example.

In the example described in this exemplary embodiment, one pixel is formed of discharge cells of R, G, and B three colors. Also a panel that includes discharge cells that form a pixel of four or more colors can use the configuration shown in this exemplary embodiment and provide the same advantage.

The specific numerical values shown in the exemplary embodiment of the present invention are set based on the characteristics of panel 10 that has a 50-inch screen and 1080 display electrode pairs 24, and simply show examples in the exemplary embodiment. The present invention is not limited to these numerical values. Preferably, each numerical value is set optimally for the characteristics of the panel, the specification of the plasma display apparatus, or the like. Variations are allowed for each numerical value within the range in which the above advantages can be obtained. Further, the number of subfields, the luminance weights of the respective subfields, or the like is not limited to the values shown in the exemplary embodiments of the present invention. The subfield structure may be switched based on image signals, for example.

### INDUSTRIAL APPLICABILITY

The present invention can stably cause an address discharge while shortening an address period, and thus enhance the image display quality in a plasma display apparatus usable as a 3D image display apparatus. Thus, the present invention is useful as a plasma display apparatus driving method, a plasma display apparatus, and a plasma display system.

### REFERENCE MARKS IN THE DRAWINGS

10 Panel
21 Front substrate
22 Scan electrode
23 Sustain electrode
24 Display electrode pair
25, 33 Dielectric layer
26 Protective layer
31 Rear substrate
32 Data electrode
34 Barrier rib
35 Phosphor layer
40 Plasma display apparatus
41 Image signal processing circuit
42 Data electrode driver circuit
43 Scan electrode driver circuit
44 Sustain electrode driver circuit
45 Timing generation circuit
46 Timing signal output part
50 Pair of shutter glasses
52R Right eye shutter
52L Left eye shutter

1. A plasma display apparatus driving method,
the plasma display apparatus including:
a plasma display panel having a plurality of discharge cells arranged therein, each of the discharge cells having a scan electrode, a sustain electrode, and a data electrode; and
a driver circuit for driving the plasma display panel,
the driving method comprising:
alternately displaying a field for a right eye and a field for a left eye on the plasma display panel, an image signal for the right eye being displayed in the field for the right eye, an image signal for the left eye being displayed in the field for the left eye, in each of the field for the right eye and the field for the left eye, a subfield having a smallest luminance weight occurring first, a subfield having a largest luminance weight occurring next, other subfields occurring thereafter;
in the subfield having the smallest luminance weight and the subfield having the largest luminance weight, performing one-line address operation for applying a scan pulse to each scan electrode; and
in the other subfields, performing two-line simultaneous address operation for applying a scan pulse simultaneously to two adjacent scan electrodes.

2. The plasma display apparatus driving method of claim 1, wherein a timing signal in synchronization with the field for the right eye and the field for the left eye is output.

3. A plasma display apparatus comprising:
a plasma display panel having a plurality of discharge cells arranged therein, each of the discharge cells having a scan electrode, a sustain electrode, and a data electrode; and
a driver circuit for driving the plasma display panel,
wherein, the driver circuit alternately displays a field for a right eye and a field for a left eye on the plasma display panel, an image signal for the right eye being displayed in the field for the right eye, and an image signal for the left eye being displayed in the field for the left eye, in each of the field for the right eye and the field for the left eye, a subfield having a smallest luminance weight occurring first, a subfield having a largest luminance weight occurring next, and other subfields occurring thereafter,
in the subfield having the smallest luminance weight and the subfield having the largest luminance weight, the driver circuit performs one-line address operation for applying a scan pulse to each scan electrode, and
in the other subfields, the driver circuit performs two-line simultaneous address operation for applying a scan pulse simultaneously to two adjacent scan electrodes.

4. The plasma display apparatus of claim 3, wherein the driver circuit has a timing signal output part for outputting a timing signal in synchronization with the field for the right eye and the field for the left eye.

5. A plasma display system comprising:
a plasma display panel having a plurality of discharge cells arranged therein, each of the discharge cells having a scan electrode, a sustain electrode, and a data electrode;
a driver circuit for alternately displaying a field for a right eye and a field for a left eye on the plasma display panel, an image signal for the right eye being displayed in the field for the right eye, an image signal for the left eye being displayed in the field for the left eye, in each of the field for the right eye and the field for the left eye, a subfield having a smallest luminance weight occurring first, a subfield having a largest luminance weight occurring next, and other subfields occurring thereafter, wherein
the driver circuit drives the plasma display panel in a manner such that, in the subfield having the smallest luminance weight and the subfield having the largest luminance weight, one-line address operation for applying a scan pulse to each scan electrode is performed, and in the other subfields, two-line simultaneous address operation for applying a scan pulse simultaneously to two adjacent scan electrodes is performed, and
the driver circuit includes a timing signal output part for outputting a timing signal in synchronization with the field for the right eye and the field for the left eye; and
a pair of shutter glasses for opening and closing a right eye shutter and a left eye shutter based on a timing signal output from the timing signal output part.
